(19) United States
(12) Patent Application Publication
(10) Pub. No.: US 2021/0143541 A1
(43) Pub. Date: May 13, 2021

(54) ANTENNA ASSEMBLY

(71) Applicant: Aptiv Technologies Limited, St. Michael (BB)

(72) Inventor: Thomas Reul, Rossdorf (DE)

(21) Appl. No.: 16/681,985

(22) Filed: Nov. 13, 2019

(51) Int. Cl. H01Q 1/48; H01Q 1/12; H01Q 13/10

(52) U.S. Cl. CPC H01Q 1/48; H01Q 13/10; H01Q 1/1271

(57) ABSTRACT

An antenna assembly configured to be mounted on a glass panel of a vehicle and optimized for performance in a range 2.45 to 5 GHz includes a generally rectangular substrate, an antenna element disposed on a surface of the substrate, and at least one ground element disposed on the surface of the substrate. The antenna assembly may include a coaxial connector mounted directly to the substrate and may include a flexible substrate portion located between the coaxial connector and the antenna and ground elements. The antenna assembly may alternatively include a coaxial cable connected directly to the antenna and ground elements

### TECHNICAL FIELD OF THE INVENTION

The invention generally relates to an antenna assembly, particularly to an antenna assembly configured to use in a vehicle.

### BACKGROUND OF THE INVENTION

Antenna assemblies are required for numerous automotive applications, such as vehicle-to-vehicle (V2V), vehicle-to-infrastructure (V2I), vehicle-to-everything (V2X), and dedicated short range communication. These antenna assemblies are typically connected by coaxial cables which consist of an outer shield conductor, an inner center conductor, a dielectric between the outer shield conductor and the inner center conductor, and an insulation jacket.

In order to standardize various types of connectors used with coaxial cables and thereby avoid confusion, certain industry standards have been established. One of these standards is referred to as FAKRA. FAKRA is the Automotive Standards Committee in the German Institute for Standardization (in German “Deutsches Institut für Normung”, best known by the acronym DIN), representing international standardization interests in the automotive field. The FAKRA standard provides a system, based on keying and color coding, for proper connector attachment. Socket keys can only be connected to matching plug keyways in FAKRA connectors. Secure positioning and locking of connector housings is facilitated by way of a FAKRA defined catch on the socket housing and a cooperating latch on the plug housing. The FAKRA standard is contained in the USCAR-17 and USCAR-18 standards jointly published by the United States Council for Automotive Research (USCAR) and the Society of Automotive Engineers (SAE).

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

According to a first example embodiment of the invention, an antenna assembly is provided. The antenna assembly includes a substrate having a longitudinal length greater than a lateral length and having a first end and a second end longitudinally opposite the first end, an antenna element disposed on a surface of the substrate, and a pair of ground elements disposed on the surface of the substrate. The antenna element is located on the substrate closer to the first end than the second end and the pair of ground elements are located on the substrate closer to the second end than the first end.

In a second example embodiment having one or more features of the first example embodiment, the antenna assembly is configured to be attached to a transparent panel within a vehicle.

In a third example embodiment having one or more features of the antenna assembly of the first or second example embodiments, the antenna element does not longitudinally overlap the pair of ground elements.

In a fourth example embodiment having one or more features of the antenna assembly of any one of the previous example embodiments, the antenna element has a generally rectangular shape which defines a central slot and an edge slot in communication with the central slot sized, shaped, and arranged such that the antenna element does not completely surround the central slot.

In a fifth example embodiment having one or more features of the antenna assembly of the fourth example embodiment, the edge slot is arranged adjacent to a lateral edge of the substrate.

In a sixth example embodiment having one or more features of the antenna assembly of any one of the previous example embodiments, a first ground element of the pair of ground elements defines a rectangular shape having a first major longitudinal length and a first minor lateral width.

In a seventh example embodiment having one or more features of the antenna assembly of the sixth example embodiment, a second ground element of the pair of ground elements includes a longitudinal portion with a second major longitudinal length and a second minor lateral width, a first lateral portion extending from a first end of the longitudinal portion having a first major lateral width and a first minor longitudinal length, and a second lateral portion extending from a second end of the longitudinal portion having a second major lateral width and a second minor longitudinal length.

In an eighth example embodiment having one or more features of the antenna assembly of the seventh example embodiment, the second major longitudinal length of the second ground element is greater than the first major longitudinal length of the first ground element.

In a ninth example embodiment having one or more features of the antenna assembly of either of the seventh or eighth example embodiments, the first end of the longitudinal portion is closer to the antenna element than the second end and wherein the first major lateral width of the first lateral portion is greater than the second major lateral width of the second lateral portion.

In a tenth example embodiment having one or more features of the antenna assembly of any one of the three previous example embodiments, the antenna assembly further includes a coaxial connector mechanically attached to the substrate having a central terminal electrically interconnected to the antenna element and a shield terminal circumferentially surrounding the central terminal and electrically interconnected to the pair of ground elements. The antenna element is located on the substrate closer to the first end than the second end and the pair of ground elements are located on the substrate closer to the second end than the first end.

In an eleventh example embodiment having one or more features of the antenna assembly of the tenth example embodiment, the central terminal is interconnected to the antenna element by an antenna trace and the pair of ground elements are each attached to the shield terminal by ground traces. The antenna trace is disposed intermediate the pair of ground elements.

In a twelfth example embodiment having one or more features of the antenna assembly of the eleventh example embodiment, the substrate includes a first rigid portion on which the antenna element and the pair of ground elements are disposed, a second rigid portion on which the coaxial connector is disposed, and a flexible portion intermediate the first and second rigid portions. The antenna trace and the ground traces traverse the flexible portion.

In a thirteenth example embodiment having one or more features of the antenna assembly of any one of the three previous example embodiments, the coaxial connector conforms to USCAR 17-5 and USCAR 18-4 standards.

In a fourteenth example embodiment having one or more features of the antenna assembly of the ninth example embodiment, the antenna assembly further includes a ground trace interconnecting the first and second ground elements and a coaxial cable having a central signal conductor and a shield conductor surrounding at least a portion of the signal conductor. The signal conductor is electrically and mechanically attached to the antenna element and the shield conductor is electrically and mechanically attached to the ground trace.

In a fifteenth example embodiment having one or more features of the antenna assembly of the fourteenth example embodiment, the signal conductor is soldered directly to the antenna element and the shield conductor is soldered directly to the ground trace.

In a sixteenth example embodiment having one or more features of the antenna assembly of the fifteenth example embodiment, the antenna assembly further includes a coaxial connector mechanically attached to an end of the coaxial cable opposite the attachments of the coaxial cable to the antenna element and the ground trace. The coaxial connector having a central terminal electrically interconnected to central conductor and a shield terminal circumferentially surrounding the central terminal and electrically interconnected to the shield conductor. The coaxial connector conforms to USCAR 17-5 and USCAR 18-4 standards.

In a seventeenth example embodiment having one or more features of the antenna assembly of either of the two previous example embodiments, the ground trace extends laterally between the first ground element and the first lateral portion of the second ground element.

In an eighteenth example embodiment having one or more features of the antenna assembly of any one of the previous example embodiments, the antenna assembly further includes means for attaching the substrate to a transparent panel within a vehicle.

In a nineteenth example embodiment having one or more features of the antenna assembly of any one of the previous example embodiments, the antenna assembly has a gain of at least 2.79 and an efficiency of at least 68% when operating in a frequency range of 2.4 to 2.5 GHz.

In a twentieth example embodiment having one or more features of the antenna assembly of any one of the previous example embodiments, the antenna assembly has a gain of at least 3.38 and an efficiency of at least 58% when operating in a frequency range of 4.9 to 5.875 GHz.

According to a twenty-first example embodiment of the invention, an antenna assembly is provided. The antenna assembly includes a substrate a substrate, an antenna element disposed on a surface of the substrate, a ground elements disposed on the surface of the substrate, and a coaxial connector mechanically attached to the substrate having a central terminal electrically interconnected to the antenna element and a shield terminal circumferentially surrounding the central terminal and electrically interconnected to the ground element.

In a twenty-second example embodiment having one or more features of the antenna assembly of the twenty-first example embodiment, the substrate includes a first rigid portion on which the antenna element and the ground element are disposed, a second rigid portion on which the coaxial connector is disposed, and a flexible portion intermediate the first and second rigid portions.

In a twenty-third example embodiment having one or more features of the antenna assembly of the twenty-first or twenty-second example embodiment, the coaxial connector conforms to USCAR 17-5 and USCAR 18-4 standards.

### BRIEF DESCRIPTION OF THE SEVERAL VIEWS OF THE DRAWING

The present invention will now be described, by way of example with reference to the accompanying drawings, in which:

FIG. 1 is a top view of an antenna assembly in accordance with a first embodiment of the invention;

FIG. 2A is a top view of an antenna assembly in accordance with a second embodiment of the invention;

FIG. 2B is a side view of the antenna assembly of FIG. 2A in accordance with the second embodiment of the invention;

FIG. 3 is a perspective view of the antenna assembly of FIG. 2A in accordance with the second embodiment of the invention;

FIG. 4 is a table of performance specifications of the antenna assemblies of FIG. 1 and FIG. 2A according to multiple embodiments of the invention;

FIG. 5A is a graph of a radiation pattern of the antenna assemblies of FIG. 1 and FIG. 2A in the azimuth plane at 2.45 Gigahertz (GHz) according to multiple embodiments of the invention;

FIG. 5B is a graph of a radiation pattern of the antenna assemblies of FIG. 1 and FIG. 2A in the phi zero degree plane at 2.45 GHz according to multiple embodiments of the invention;

FIG. 5C is a graph of a radiation pattern of the antenna assemblies of FIG. 1 and FIG. 2A in the phi ninety degree plane at 2.45 GHz according to multiple embodiments of the invention;

FIG. 5D is a graph of a radiation pattern of the antenna assemblies of FIG. 1 and FIG. 2A in the azimuth plane at 5.47 GHz according to multiple embodiments of the invention;

FIG. 5E is a graph of a radiation pattern of the antenna assemblies of FIG. 1 and FIG. 2A in the phi zero degree plane at 5.47 GHz according to multiple embodiments of the invention;

FIG. 5F is a graph of a radiation pattern of the antenna assemblies of FIG. 1 and FIG. 2A in the phi ninety degree plane at 5.47 GHz according to multiple embodiments of the invention;

FIG. 6 is a graph of return loss of the antenna assemblies of FIG. 1 and FIG. 2A according to multiple embodiments of the invention;

FIG. 7 is a graph of the return loss of the antenna assembly of FIG. 2A in free space according to the second embodiment of the invention;

FIG. 8 is a perspective view of the antenna assembly of FIG. 2A mounted to a rear transparent panel of a vehicle according to the second embodiment of the invention;

FIG. 9 is a graph of the return loss of the antenna assembly of FIG. 2A mounted to the rear transparent panel of the vehicle according to the second embodiment of the invention;

FIG. 10 is a perspective view of the antenna assembly of FIG. 2A mounted to a side transparent panel of a vehicle according to the second embodiment of the invention;

FIG. 11 is a graph of the return loss of the antenna assembly of FIG. 2A mounted to the side transparent panel of the vehicle according to the second embodiment of the invention;

FIG. 12 is a perspective view of the antenna assembly of FIG. 2A mounted to a front transparent panel of a vehicle according to the second embodiment of the invention;

FIG. 13 is a graph of the return loss of the antenna assembly of FIG. 2A mounted to the front transparent panel of the vehicle according to the second embodiment of the invention; and

FIG. 14 is an overlay graph of the return loss of the antenna assembly of FIGS. 10-13 comparing the antenna performance according to the second embodiment of the invention.

In the figures and in the following description, similar elements share the last two digits of the reference numbers.

### DETAILED DESCRIPTION OF THE INVENTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Non-limiting examples of antenna assemblies 100, 200 are shown in FIGS. 1 through 3. The antenna assemblies 100, 200 are optimized for performance in a range 2.45 to 5 (GHz) for wireless local area networks applications conforming to Institute of Electrical and Electronics Engineers (IEEE) 801.11b/g/n standards, BLUETOOTH applications, and/or dedicated short range communication (DSRC) applications conforming to IEEE 802.11p standards. The antenna assemblies 100, 200 have a gain of at least 2.79 and an efficiency of at least 68% when operating in a frequency range of 2.4 to 2.5 GHz and a gain of at least 3.38 and an efficiency of at least 58% when operating in a frequency range of 4.9 to 5.875 GHz. The antenna assemblies 100, 200 have a nominal impedance of 50 ohms and a voltage standing wave ratio (VSWR) of 2:1. The antenna assemblies 100, 200 have a vertical polarization with an omnidirectional radiation pattern.

Each of the antenna assemblies 100, 200 have includes a substrate 102, 202 having a generally rectangular shape in which a longitudinal length extending along a longitudinal axis is greater than a lateral length extending along a lateral axis. As used herein, the longitudinal axis is orthogonal to the lateral axis. The substrate has a first end and a second end that is arranged longitudinally opposite to the first end. The substrate 102, 202 may be a printed circuit board substrate that is made of epoxy-resins or polyimide-resins. The resin may be reinforced with a woven glass cloth or other matrix such as chopped fibers. Substrates formed of such materials are typically referred to as FR-4 or G-10 type circuit boards. The substrate may alternatively be constructed of ceramic or rigid polymer materials. This listing of acceptable substrate materials is not exhaustive and other materials may also be used successfully. In the illustrated example, the substrate has a thickness of about 0.1 millimeter (mm) thick. Other embodiments may be envisioned in which the substrate thickness may be up to 2.36 mm thick.

The antenna assemblies 100, 200 have also include an antenna element 104, 204 disposed on an upper surface 106, 206 of the substrate 102, 202 and a pair of ground elements 108, 208 that are also disposed on the upper surface 106, 206 of the substrate 102, 202. The antenna element 104, 204 is arranged on the substrate 102, 202 such that it is closer to the first end of the substrate than the second end and the pair of ground elements 108, 208 are arranged on the substrate 102, 202 such that they closer to the second end than the first end. The antenna element 104, 204 and ground elements 108, 208 are formed on the upper surface 106, 206 of the substrate 102, 202 from an electrically conductive foil, e.g. a metallized polyethylene terephthalate (PET) film; having a thickness of about 100 micrometers (μm). The antenna element 104, 204 is arranged on the substrate 102, 202 so that it does not longitudinally overlap the pair of ground elements 108, 208. The antenna element 104, 204 has a generally rectangular shape with a major longitudinal length and a minor lateral width. The antenna element 104, 204 defines a central slot 110, 210 and an edge slot 112, 212 that is connected to, i.e. in communication with, the central slot 110, 210. The edge slot 112, 212 is sized, shaped, and arranged such that the antenna element 104, 204 does not completely surround the central slot 110, 210, thereby forming a squared C-shape. The edge slot 112, 212 is biased in the antenna element 104, 204 towards the second end of the substrate. The edge slot 112, 212 is arranged such that it is adjacent to a lateral edge of the substrate. The portion of the substrate 102, 202 on which the antenna element 104, 204 and ground elements 108, 208 are disposed has a longitudinal dimension of 36 mm and a lateral dimension of 12 mm.

A first ground element 114, 214 of the pair of ground elements 108, 208 defines a rectangular shape that has a first major longitudinal length and a first minor lateral width. A second ground element 116, 216 of the pair of ground elements includes a longitudinal body portion 118, 218 with a second major longitudinal length and a second minor lateral width, a lateral first leg portion 120, 220 extending from a first end of the body portion 118, 218 having a first major lateral width and a first minor longitudinal length, and a lateral second leg portion 122, 222 extending from a second end of the body portion 118, 218 having a second major lateral width and a second minor longitudinal length. The second major longitudinal length of the second ground element 116, 216 is greater than the first major longitudinal length of the first ground element 114, 214.

The first end of the body portion 118, 218 is closer to the antenna element 104, 204 than the second end and the first major lateral width of the first leg portion 120, 220 is greater than the second major lateral width of the second leg portion 122, 222.

The antenna assembly 100 of FIG. 1 includes a coaxial connector 124 that is mechanically attached to the substrate 102. The coaxial connector 124 has a central terminal (not shown) that is electrically interconnected to the antenna element 104 and a shield terminal (not shown) that circumferentially surrounds the central terminal and is electrically interconnected to the pair of ground elements 108. The coaxial connector 124 in the illustrated example is a low profile FAKRA connector which conforms to USCAR 17-5 and USCAR 18-4 standards. Other embodiments using different coaxial connector types, such as SMB. The antenna element 104 is arranged on the substrate 102 such that it is closer to the first end than the second end of the substrate 102. The pair of ground elements 108 are arranged on the substrate to be closer to the second end of the substrate 102 than the first end. As such, the pair or ground elements 108 are disposed on the substrate 102 intermediate the coaxial connector 124 and the antenna element 104. The central terminal is interconnected to the antenna element 104 by an electrically conductive circuit board trace, referred to herein as an antenna trace 126 on the upper surface 106 of the substrate 102 and the pair of ground elements 108 are each attached to the shield terminal by electrically conductive circuit board traces, referred to herein as ground traces 128 on the upper surface 106 of the substrate 102. The antenna trace 126 is arranged on the substrate 102 so that it runs intermediate or between the pair of ground elements 108.

The substrate 102 includes a first rigid portion 130 on which the antenna element 104 and the pair of ground elements 108 are disposed, a second rigid portion 132 on which the coaxial connector 124 is disposed, and a flexible portion 134 intermediate the first and second rigid portions 130, 132. The flexible portion 134 may be formed of a polyamide material. The antenna trace 126 and the ground traces 128 traverse the flexible portion 134 of the substrate 102. The flexible portion 134 allows for the antenna assembly 100 to better to conform to the surface it is being applied to, especially surfaces that are curved. The flexible portion 134 allow the antenna assembly 100 to sit flatter against the surface and thereby save packaging space.

The antenna assembly 200 shown in FIGS. 2A-3 includes a coaxial cable 236, e.g. RG-174 cable, having a central signal conductor 238 and a shield conductor 240 surrounding at least a portion of the signal conductor 238. The signal conductor 238 is electrically and mechanically attached to the antenna element 204 and the shield conductor 240 is electrically and mechanically attached to the pair of ground elements 208 by a conductive ground trace 242 that interconnects the first and second ground elements 214, 216. In the illustrated example, the signal conductor 238 of the coaxial cable 236 is soldered directly to the antenna element 204 and the shield conductor 240 is soldered directly to the ground trace 242. The ground trace 242 has a T-shape interconnecting the first ground element 214 and the first leg portion 120 of the second ground element 216 and extending longitudinally between the first and second ground elements 214, 216.

The antenna assembly 200 also includes a coaxial connector 244 that is mechanically attached to an end of the coaxial cable 236 opposite the attachments of the coaxial cable 236 to the antenna element 204 and the ground trace 242. The coaxial connector 244 has a central terminal (not shown) electrically interconnected to the central conductor and a shield terminal (not shown) circumferentially surrounding the central terminal and electrically interconnected to the shield conductor 240. The coaxial connector 244 shown in FIG. 3 is a FAKRA connector which conforms to USCAR 17-5 and USCAR 18-4 standards.

FIGS. 5A-5E shows that radiation patterns of the antenna assemblies 100, 200 in the vertical (azimuth) plane, the longitudinal (phi 0 degree) plane, and the lateral (phi 90 degree) plane at frequencies of 2.45 GHz and 5.47 Ghz.

FIG. 6 is a graph of return loss of the antenna assemblies 100, 200 in the frequency range of 2 GHz to 6 GHz.

FIG. 7 is a graph of the return loss of the antenna assembly 200 in free space in the frequency range of 1 GHz to 7 GHz.

FIG. 8 shows the antenna assembly 200 mounted to a transparent panel, e.g. a rear window (back glass) 352 of a vehicle 350. FIG. 9 is a graph of the return loss of the antenna assembly 200 when mounted to the rear window 352 of the vehicle 350 in the frequency range of 1 GHz to 7 GHz.). The rear window may be formed of a transparent material such as a glass or polycarbonate material.

FIG. 10 shows the antenna assembly 200 mounted to another transparent panel, e.g. a side window (side glass) 354 of the vehicle 350. FIG. 11 is a graph of the return loss of the antenna assembly 200 when mounted to the side window 354 of the vehicle 350 in the frequency range of 1 GHz to 7 GHz. The side window may be formed of a transparent material such as a glass or polycarbonate material.

FIG. 12 shows the antenna assembly 200 mounted to yet another transparent panel, e.g. a windshield (windscreen) 356 of the vehicle 350. FIG. 13 is a graph of the return loss of the antenna assembly 200 when mounted to the windshield 356 of the vehicle in the frequency range of 1 GHz to 7 GHz. The windshield may be formed of a transparent material such as a glass or polycarbonate material.

Alternative embodiments of the invention may be envisioned in which the antenna assembly 100, 200 is attached to a translucent or opaque panel formed of a nonmetallic or dielectric material.

FIG. 14 is an overlay graph of the return loss of the antenna assembly of FIGS. 7, 9, 11, and 13 to more easily compare the return loss of the antenna 200 in the frequency range of 1 GHz to 7 GHz.

FIGS. 4-6 show examples of the substrate 202 of the antenna assembly 200 attached to a glass panel of a vehicle 350, such as a windshield (windscreen) 352, rear window (back glass) 354, or side window (side glass) 356. In some vehicle applications, it may be desirable to mount one of the antenna assemblies on the windshield 352, a left side window 356, the rear window 354, and a right side window 356 for improved signal reception and transmission by a vehicle mounted transceiver (not shown).

FIG. 10 is a graph of the return loss of the antenna assembly 200 in free space. FIG. 11 is a graph of the return loss of the antenna assembly 200 mounted to the rear window of a vehicle according to the second embodiment of the invention;

FIG. 12 is a graph of the return loss of the antenna assembly of FIG. 2A mounted to a side glass panel of a vehicle according to the second embodiment of the invention;

FIG. 13 is a graph of the return loss of the antenna assembly of FIG. 2A mounted to a front glass panel of a vehicle according to the second embodiment of the invention; and

FIG. 14 is an overlay graph of the return loss of the antenna assembly of FIGS. 10-13 comparing the antenna performance according to the second embodiment of the invention.

The antenna assembly 200 may be attached to the windshield 356, the rear window 352, or the side window 354 by an adhesive tape, e.g. 3M #467 double sided adhesive tape manufactured by the 3M Corporation of Minneapolis, Minn. Alternatively, the antenna assembly may be attached by metallic pads on the lower surface of the substrate opposite the top surface that are soldered to metallic pads on the glass panel, conductive adhesives, or a mechanical spring contact.

Accordingly, an antenna assembly is provided. The antenna assembly provides the benefits of reducing cost and complexity by incorporating an antenna into the window surface which will be more cost effective and improve aesthetics of the vehicle by removing exterior mounted antennae, e.g. a “shark fin” antenna. By incorporating the antenna and coaxial cable interface on the window surface, the need for a secondary module receiver could be eliminated as well as the intermediate wire harness from the glass surface to the module. This would allow for direct coaxial cable connection from the glass surface directly to the receiving unit in the vehicle. This would improve antenna performance and reduce cost and complexity in the vehicle. Exterior mounted antennas also are a common failure point due to environmental exposure. Incorporating the antenna assemblies into the interior of the vehicle would be eliminate these failure modes.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments, and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

We claim:

1. An antenna assembly, comprising:
a substrate having a longitudinal length greater than a lateral length and having a first end and a second end longitudinally opposite the first end;
an antenna element disposed on a surface of the substrate; and
a pair of ground elements disposed on the surface of the substrate, wherein the antenna element is located on the substrate closer to the first end than the second end and the pair of ground elements are located on the substrate closer to the second end than the first end.

2. The antenna assembly according to claim 1, wherein the antenna assembly is configured to be attached to a glass panel within a vehicle.

3. The antenna assembly according to claim 1, wherein the antenna element does not longitudinally overlap the pair of ground elements.

4. The antenna assembly according to claim 1, wherein the antenna element has a generally rectangular shape which defines a central slot and an edge slot in communication with the central slot sized, shaped, and arranged such that the antenna element does not completely surround the central slot.

5. The antenna assembly according to claim 4, wherein the edge slot is arranged adjacent to a lateral edge of the substrate.

6. The antenna assembly according to claim 1, wherein a first ground element of the pair of ground elements defines a rectangular shape having a first major longitudinal length and a first minor lateral width.

7. The antenna assembly according to claim 6, wherein a second ground element of the pair of ground elements includes a longitudinal portion with a second major longitudinal length and a second minor lateral width, a first lateral portion extending from a first end of the longitudinal portion having a first major lateral width and a first minor longitudinal length, and a second lateral portion extending from a second end of the longitudinal portion having a second major lateral width and a second minor longitudinal length.

8. The antenna assembly according to claim 7, wherein the second major longitudinal length of the second ground element is greater than the first major longitudinal length of the first ground element.

9. The antenna assembly according to claim 7, wherein the first end of the longitudinal portion is closer to the antenna element than the second end and wherein the first major lateral width of the first lateral portion is greater than the second major lateral width of the second lateral portion.

10. The antenna assembly according to claim 7, further comprising:
a coaxial connector mechanically attached to the substrate having a central terminal electrically interconnected to the antenna element and a shield terminal circumferentially surrounding the central terminal and electrically interconnected to the pair of ground elements, wherein the antenna element is located on the substrate closer to the first end than the second end and the pair of ground elements are located on the substrate closer to the second end than the first end.

11. The antenna assembly according to claim 10, wherein the central terminal is interconnected to the antenna element by an antenna trace and the pair of ground elements are each attached to the shield terminal by ground traces, wherein the antenna trace is disposed intermediate the pair of ground elements.

12. The antenna assembly according to claim 11, wherein the substrate includes a first rigid portion on which the antenna element and the pair of ground elements are disposed, a second rigid portion on which the coaxial connector is disposed, and a flexible portion intermediate the first and second rigid portions, wherein the antenna trace and the ground traces traverse the flexible portion.

13. The antenna assembly according to claim 9, further comprising a ground trace interconnecting the first and second ground elements and a coaxial cable having a central signal conductor and a shield conductor surrounding at least a portion of the signal conductor, wherein the signal conductor is electrically and mechanically attached to the antenna element and the shield conductor is electrically and mechanically attached to the ground trace.

14. The antenna assembly according to claim 13, wherein the signal conductor is soldered directly to the antenna element and the shield conductor is soldered directly to the ground trace.

15. The antenna assembly according to claim 14, further comprising a coaxial connector mechanically attached to an end of the coaxial cable opposite the attachments of the coaxial cable to the antenna element and the ground trace, the coaxial connector having a central terminal electrically interconnected to central conductor and a shield terminal circumferentially surrounding the central terminal and electrically interconnected to the shield conductor, wherein the coaxial connector conforms to USCAR 17-5 and USCAR 18-4 standards.

16. The antenna assembly according to claim 13, wherein the ground trace extends laterally between the first ground element and the first lateral portion of the second ground element.

17. The antenna assembly according to claim 1, further comprising:
means for attaching the substrate to a glass panel within a vehicle.

18. The antenna assembly according to claim 1, wherein the antenna assembly has a gain of at least 2.79 and an efficiency of at least 68% when operating in a frequency range of 2.4 to 2.5 GHz.

19. The antenna assembly according to claim 1, wherein the antenna assembly has a gain of at least 3.38 and an efficiency of at least 58% when operating in a frequency range of 4.9 to 5.875 GHz.

20. An antenna assembly, comprising:
a substrate;
an antenna element disposed on a surface of the substrate;
a ground element disposed on the surface of the substrate; and
a coaxial connector mechanically attached to the substrate having a central terminal electrically interconnected to the antenna element and a shield terminal circumferentially surrounding the central terminal and electrically interconnected to the ground element.

21. The antenna assembly according to claim 20, wherein the substrate includes a first rigid portion on which the antenna element and the ground element are disposed, a second rigid portion on which the coaxial connector is disposed, and a flexible portion intermediate the first and second rigid portions.
